(19) United States
(12) Patent Application Publication
(10) Pub. No.: US 2015/0262535 A1
(43) Pub. Date: Sep. 17, 2015

(54) Liquid Crystal Display and Driving Method Thereof

(71) Applicant: Shenzhen China Star Optoelectronicsa Technology Co., Ltd., Shenzhen (CN)

(72) Inventor: Yong Fan, Shenzhen (CN)

(73) Assignee: Shenzhen China Star Optoelectronics Technology Co., Ltd., Shenzhen (CN)

(21) Appl. No.: 14/360,374

(22) PCT Filed: Mar. 18, 2014
(86) PCT No.: PCT/CN2014/073595

§ 371 Date: May 23, 2014

(30) Foreign Application Priority Data
Mar. 13, 2014 (CN) 20140093579.0

(51) Int. Cl. G09G 3/34; G09G 3/36; G02F 1/133; G02F 1/1335; G02F 1/1343

(52) U.S. Cl. CPC G09G 3/3413; G02F 1/133621; G02F 1/133514; G02F 1/133603; G02F 1/134309; G02F 1/13306; G09G 3/36; G02F 2001/133624; G02F 2001/134345; G09G 2320/064; G09G 2320/0646

(57) ABSTRACT

The present invention provides a liquid crystal display, which comprises a display panel, a backlight module, and a driving module; wherein, the display panel comprises a filter substrate. The filter substrate comprises multiple filter units. Each filter unit comprises a red filter, a blue filter, and a transparent filter. The backlight module comprises a first backlight and a green backlight. The first backlight is formed by packaging a blue light emitting chip and a red phosphor. The present invention further provides a driving method of liquid crystal display. The liquid crystal display and the driving method thereof can not only reduce the consumption of the backlight by the transparent filter provided on the filter substrate, improving the utilization of the backlight; but also reduce the usage of green light emitting chip through the first backlight formed by packaging a blue light emitting chip and a red phosphor. At the same time, the liquid crystal display further has a high color performance.

### BACKGROUND OF THE INVENTION

1. Field of the Invention

The present invention relates to the field of liquid crystal display, and in particular to a liquid crystal display and the driving method thereof.

2. The Related Arts

The existing technology is vigorously developed, the old information Commodities give place to the new to meet the different needs of the public. Most of the early display devices are cathode ray tube (CRT) display. Because of its large size and large power consumption, and the generated radiation is harmful for the user using the monitor for a long time, the traditional CRT displays are gradually replaced by the liquid crystal display (LCD) in the existing commercial displays.

The liquid crystal display has many advantages of thin body, power saving, no radiation, etc., which is widely used. Referring to FIG. 1, it is a liquid crystal display according to the existing technology, which comprises a backlight module 10, a display panel 20, and a driving module 50. The display panel 20 comprises a lower polarizing layer 21, an array substrate 23, a liquid crystal layer 25, a filter substrate 24, and a upper polarizing layer 22 provided in the direction away from the backlight module 10. Wherein, the backlight module 10 is provided with a white light source 11 thereon; the filter substrate 24 comprises multiple filter units, each filter unit comprises a red filter 241, a green filter 242, and a blue filter 243. When displaying, the driving module 50 drives the white light source 11 to emit light and drives the red sub-pixel, the blue sub-pixel, and the green sub-pixel to display at the same time. Wherein, the grayscale driving the red sub-pixel, the blue sub-pixel, and the green sub-pixel is determined by the image screen information.

However, in this liquid crystal display, the filter substrate 24 has higher light consumption, leading to lower utilization of the white light source 11, which is smaller than 33%. In order to improve the utilization of the backlight module 10, it proposes a new display method recently. Referring to FIG. 2, it is a liquid crystal display according to the existing technology, which comprises a backlight module 30, a display panel 20, and a driving module 50. The display panel 20 comprises a lower polarizing layer 21, an array substrate 23, a liquid crystal layer 25, a filter substrate 26, and a upper polarizing layer 22 provided in the direction away from the backlight module 30. Wherein, the backlight module 30 is provided with a white light source 31 and a green light source 32 thereon; the filter substrate 26 comprises multiple filter units, each filter unit comprises a red filter 261, a transparent filter 262, and a blue filter 263. The displays are divided into odd frames and even frames. As in odd frames, the driving module 50 drives the white light source 31 to emit light and drives the red sub-pixel and the blue sub-pixel to display at the same time; as in even frames, the driving module 50 drives the green light source 32 to display and drives the green sub-pixel to display at the same time. Under continuous alternation of the odd frames and the even frames, it can display the complete images. However, in this display method, the white light source is usually made of red light-emitting chips, blue emitting chips and green light-emitting chips, or made of blue light-emitting chips, green light-emitting chips, and red phosphor. If it is made of red light-emitting chips, blue emitting chips and green light-emitting chips, the costs is high, the driving is complex, and the decay lifetimes of three different color chips are inconsistent, leading to chromaticity drift, and then reduce the display quality of the liquid crystal display; If it is made of blue light-emitting chips, green light-emitting chips, and red phosphor, the driving method is more complex, and the utilization of the backlight module 30 is still lower.

### SUMMARY OF THE INVENTION

In order to solve the existing technical issue, the present invention is to provide a liquid crystal display and the driving method thereof, which has high backlight utilization and high color performance.

To achieve the above object, an object of the present invention is to provide a liquid crystal display, which comprises a display panel, a backlight module, and a driving module; wherein, the display panel comprises a filter substrate, the filter substrate comprises multiple filter units, each filter unit comprises a red filter, a blue filter, and a transparent filter; wherein, the backlight module comprises a first backlight and a green backlight, the first backlight is formed by packaging a blue light emitting chip and a red phosphor.

Wherein, the display panel is provided with a red sub-pixel, a blue sub-pixel, and a transparent sub-pixel thereon corresponding to the red filter, the blue filter, and the transparent filter.

Wherein, as in odd frames/even frames, the driving module drives the first backlight to emit light and drives the red sub-pixel, the blue sub-pixel, and the transparent sub-pixel to display at the same time; as in even frames/odd frames, the driving module drives the green backlight to display and drives the transparent sub-pixel to display at the same time.

Wherein, the grayscale driving the red sub-pixel, the blue sub-pixel, and the transparent sub-pixel is determined by the image screen information.

Wherein, the frequency that the driving module drives the backlight module and the display panel is 120 Hz.

Wherein, the red filter is made of a red resin, the blue filter is made of a blue resin, and the transparent filter is made of a transparent material.

Wherein, the green backlight is formed by packaging green light-emitting chips.

The another object of the present invention is to provide a driving method of liquid crystal display, which drives the liquid crystal display as claimed in claim 2, comprising: as in odd frames/even frames, driving the first backlight to emit light and driving the red sub-pixel, the blue sub-pixel, and the transparent sub-pixel to display at the same time; as in even frames/odd frames, driving the green backlight to display and driving the transparent sub-pixel to display at the same time.

Wherein, the grayscale driving the red sub-pixel, the blue sub-pixel, and the transparent sub-pixel is determined by the image screen information.

Wherein, the frequency driving the backlight and the display panel is 120 Hz.

The liquid crystal display and the driving method thereof according to the present invention can not only reduce the consumption of the backlight by the transparent filter provided on the filter substrate, improving the utilization of the backlight; but also reduce the usage of green light emitting chip through the first backlight formed by packaging a blue light emitting chip and a red phosphor. At the same time, the liquid crystal display further has a higher color performance.

### BRIEF DESCRIPTION OF THE DRAWINGS

FIG. 1 is a schematic view illustrating the structure of a liquid crystal display according to the existing technology;

FIG. 2 is a schematic view illustrating the structure of another liquid crystal display according to the existing technology; and

FIG. 3 is a schematic view illustrating the structure of a liquid crystal display according to an embodiment of the present invention.

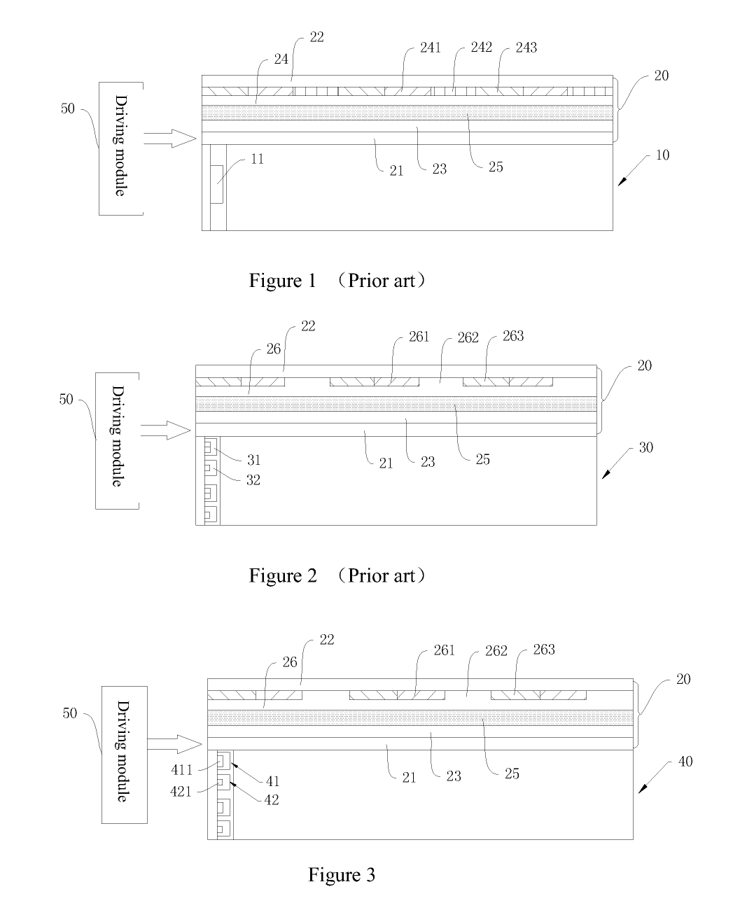

### DETAILED DESCRIPTION OF THE PREFERRED EMBODIMENTS

In order to further illustrate technical means and effects thereof according to the present invention, the accompanying drawings and the following detailed descriptions are the preferred embodiments of the present invention.

Referring to FIG. 3, it shows a liquid crystal display according to an embodiment of the present invention, which comprises a backlight module 40, a display panel 20, and a driving module 50. Wherein, the display panel 20 comprises a lower polarizing layer 21, an array substrate 23, a liquid crystal layer 25, a filter substrate 26, and a upper polarizing layer 22 provided in the direction away from the backlight module 40.

The filter substrate 26 comprises multiple filter units, and each filter unit comprises a red filter 261, a blue filter 262, and a transparent filter 263. Of course, in the other embodiments, the positions of the red filter 261, the blue filter 262, and the transparent filter 263 can changed randomly. Wherein, the red filter 261 is made of a red resin, the blue filter 263 is made of a blue resin, and the transparent filter 262 is made of a transparent material. In a preferred embodiment, the red filter 261, the blue filter 262, and the transparent filter 263 have the similar width. The display panel 20 is provided with a red sub-pixel, a blue sub-pixel, and a transparent sub-pixel thereon respectively corresponding to the red filter 261, the blue filter 263, and the transparent filter 262.

The backlight module 40 comprises a first backlight 41 and a green backlight 42. Wherein, the first backlight 41 is formed by packaging a blue light emitting chip 411 and a red phosphor. The green backlight 42 is formed by packaging green light-emitting chips 421. The driving module 50 is used to drive the backlight module 40 and the display panel 20. The first backlight 41 and the green backlight 42 in the backlight module 40 are respectively controlled by the driving module 50.

The liquid crystal display according to embodiment is a rapid response device. In a preferred embodiment, the frequency that the driving module 50 drives the backlight module and the display panel is 120 Hz. As in odd frames/even frames, the driving module 50 drives the first backlight 41 to emit light and drives the red sub-pixel, the blue sub-pixel, and the transparent sub-pixel to display at the same time; as in even frames/odd frames, the driving module 50 drives the green backlight 42 to display and drives the transparent sub-pixel to display at the same time. Wherein, the grayscale driving the red sub-pixel, the blue sub-pixel, and the transparent sub-pixel is determined by the image screen information.

Based on the same inventive concept, the present invention further provides a driving method of the above liquid crystal display. The driving method divides one image into two frames to display. The first frame drives the first backlight 41 to emit light and drives the red sub-pixel, the blue sub-pixel, and the transparent sub-pixel to display at the same time; the second frame drives the green backlight 42 to display and drives the transparent sub-pixel to display at the same time. Of course, in the other embodiments, the display of the first frame and the second frame can be reordered. In this way, in the first frame, the red sub-pixel and the blue sub-pixel respectively display red and blue, and the transparent sub-pixel displays magenta emitted from the first backlight 41. Because of the display of the transparent sub-pixel, it increases the luminous efficiency of the first backlight 41, reduces the usage of green light emitting chip 411, and then decreases the costs of the driving module 50. At the same time, referring to Table 1, because the first backlight 41 is formed by packaging a blue light emitting chip 411 and a red phosphor, the transmittance of the first backlight 41 to the red filter 261, the blue filter 262, and the transparent filter 263 is higher than that of the white light source according to the prior art when the first frame displays, which further decreases the backlight costs. As in the second frame, the red sub-pixel and the blue sub-pixel don't emit light, and the transparent sub-pixel emits filtered light. Because the transmittance of the transparent sub-pixel is greater, it improves the utilization of the green backlight 42. The driving method is rapid response driving, the driving frequency thereof is preferably 120 Hz, while the maximum frequency for the human eye to distinguish things is 24 Hz, so what the human see is the mixed images of the first frame and the second frame. Furthermore, the grayscale driving the red sub-pixel, the blue sub-pixel, and the transparent sub-pixel is determined by the image screen information. Therefore, the final image to been see is the image to be displayed.

TABLE 1
The chroma analog meter of the first frame when the present
invention and the prior art display the same image

| Backlight | Red | Transparent | Blue | Total |
|---|---|---|---|---|
| module | sub-pixel | sub-pixel | sub-pixel | transmittance |
| (R + G) + red | 0.68% | 4.75% | 0.3% | 5.72% |
| phosphor | | | | |
| B + red | 2.17% | 2.17% | 0.47% | 7.55% |
| phosphor | | | | |

In summary, the liquid crystal display and the driving method thereof according to the present invention can not only reduce the consumption of the backlight by the transparent filter provided on the filter substrate, improving the utilization of the backlight; but also reduce the usage of green light emitting chip through the first backlight formed by packaging a blue light emitting chip and a red phosphor. At the same time, the liquid crystal display further has a higher color performance.

It needs to notice that, in this article, the relational terms such as first and second is only used to distinguish one entity or operating another entity or an operation, it is not necessary to require or imply that there exists any such relationship or sequence between the entity and operation. Besides, the terms “comprise,” “include,” or any other variation are intended to cover a non-exclusive inclusion, thereby making that comprising a series of process, method, materials or apparatus of element not only comprise those elements, but also comprise other elements not expressly listed, or also comprise such inherent elements of process, method, materials or apparatus. In the absence of more restrictive conditions, limiting the elements by the statement “comprises a . . . ”, it doesn't exclude that it also exists other identical elements in comprising the process, method, materials or apparatus of element.

The preferred embodiments of the present invention have been described. It should be noted that, for those having ordinary skills in the art, any deduction or modification according to the present invention is considered encompassed in the scope of protection defined by the clams of the present invention.

What is claimed is:

1. A liquid crystal display, which comprises a display panel, a backlight module, and a driving module; wherein, the display panel comprises a filter substrate, the filter substrate comprises multiple filter units, each filter unit comprises a red filter, a blue filter, and a transparent filter; wherein, the backlight module comprises a first backlight and a green backlight, the first backlight is formed by packaging a blue light emitting chip and a red phosphor.

2. The liquid crystal display as claimed in claim 1, wherein the display panel is provided with a red sub-pixel, a blue sub-pixel, and a transparent sub-pixel thereon corresponding to the red filter, the blue filter, and the transparent filter.

3. The liquid crystal display as claimed in claim 2, wherein, as in odd frames/even frames, the driving module drives the first backlight to emit light and drives the red sub-pixel, the blue sub-pixel, and the transparent sub-pixel to display at the same time; as in even frames/odd frames, the driving module drives the green backlight to display and drives the transparent sub-pixel to display at the same time.

4. The liquid crystal display as claimed in claim 3, wherein the grayscale driving the red sub-pixel, the blue sub-pixel, and the transparent sub-pixel is determined by the image screen information.

5. The liquid crystal display as claimed in claim 4, wherein the frequency that the driving module drives the backlight module and the display panel is 120 Hz.

6. The liquid crystal display as claimed in claim 3, wherein the frequency that the driving module drives the backlight module and the display panel is 120 Hz.

7. The liquid crystal display as claimed in claim 1, wherein the red filter is made of a red resin, the blue filter is made of a blue resin, and the transparent filter is made of a transparent material.

8. The liquid crystal display as claimed in claim 1, wherein the green backlight is formed by packaging green light-emitting chips.

9. A driving method of liquid crystal display, which drives the liquid crystal display as claimed in claim 2, comprising: as in odd frames/even frames, driving the first backlight to emit light and driving the red sub-pixel, the blue sub-pixel, and the transparent sub-pixel to display at the same time; as in even frames/odd frames, driving the green backlight to display and driving the transparent sub-pixel to display at the same time.

10. The driving method of liquid crystal display as claimed in claim 9, wherein the grayscale driving the red sub-pixel, the blue sub-pixel, and the transparent sub-pixel is determined by the image screen information.

11. The driving method of liquid crystal display as claimed in claim 10, wherein the frequency driving the backlight and the display panel is 120 Hz.

12. The driving method of liquid crystal display as claimed in claim 9, wherein the frequency driving the backlight and the display panel is 120 Hz.
